(19) United States
(12) Patent Application Publication
(10) Pub. No.: US 2018/0274505 A1
(43) Pub. Date: Sep. 27, 2018

(54) FUEL FILTER SYSTEM WITH WATER EMULSIFIER

(71) Applicant: Cummins Filtration IP, Inc., Columbus, IN (US)

(72) Inventors: Mark T. Wieczorek, Cookeville, TN (US); Benoit Le Roux, Fouesnant (FR); Jean-Yves Picard, Qurmper (FR)

(73) Assignee: Cummins Filtration IP, Inc., Columbus, IN (US)

(21) Appl. No.: 15/762,799

(22) PCT Filed: Sep. 23, 2016
(86) PCT No.: PCT/US2016/053327

§ 371 Date: Mar. 23, 2018

Related U.S. Application Data
(60) Provisional application No. 62/232,607, filed on Sep. 25, 2015.

(51) Int. Cl. F02M 37/22; B01D 35/00; B01D 35/26; B01D 29/56; B01F 3/08; B01F 5/06; F02M 37/04

(52) U.S. Cl. CPC F02M 37/22; B01D 35/005; B01D 35/26; B01D 29/56; B01F 2215/0086; B01F 5/0688; F02M 37/04; B01F 2003/0842; B01F 3/0811

(57) ABSTRACT

A fuel filter system that does not require the periodic draining of a water sump. The system includes a fuel tank for storing fuel and a fuel filter fluidly coupled to the fuel tank for separating water from the fuel. A fuel pump has a suction side and a high pressure side. The high pressure side of the fuel pump is fluidly coupled to the fuel filter for pumping fuel to the fuel filter. A water emulsifier, such as an orifice, is fluidly coupled to the fuel filter to receive water and fuel from the fuel filter and form a water-fuel emulsion. The water-fuel emulsion is supplied to any point in the system on the suction side of the fuel pump, such that the water-fuel emulsion passes through the fuel pump and fuel filter.

### CROSS-REFERENCE TO RELATED APPLICATIONS

This application is related to and claims priority to U.S. Provisional Patent Application No. 62/232,607, entitled “FUEL FILTER SYSTEM WITH WATER EMULSIFIER,” filed on Sep. 25, 2015, by Wieczorek et al., which is herein incorporated by reference in its entirety and for all purposes.

### FIELD

The present application relates generally to fuel filter systems which also manage water content in fuel.

### BACKGROUND

Fuel water separator filters that filter fuel, for example diesel fuel, and also separate water from the fuel before the fuel is passed to an engine are known. Various fuel water separator filter constructions are described in, for example, U.S. Pat. Nos. 7,857,974 and 7,935,255. Fuel water separator filter systems generally require the periodic draining of water that has been removed from the fuel and stored in a water sump. The failure to drain the separated water may result in system failures, with the attendant repair and maintenance costs.

In some cases, the draining of the water separated from the fuel by the fuel water separator may be an automated process. For example, as shown in FIG. 1, a conventional fuel water separator filter system includes a jet pump configured to remove water from a water sump of a suction side fuel water separator filter utilizing the fuel in a high pressure side filter as a motive force. The jet pump includes an orifice through which the fuel from the high pressure side filter passes, producing a low pressure region after the orifice that draws the water out of the water sump. Thus, the water does not pass through the orifice with the fuel, but is introduced after the orifice of the jet pump to form a fuel water mixture. The fuel water mixture is then returned to the fuel tank, where the water separates from the fuel and accumulates in the fuel tank. Thus, the system shown in FIG. 1 avoids the requirement to periodically drain the water sump of the fuel water separator filter, but requires a periodic draining of a water sump of the fuel tank. Failure to drain the water sump of the fuel tank periodically may result in damage to the fuel system or engine and a decreased available fuel tank capacity. Additionally, draining of a water sump in a fuel water separator filter system may result in undesirable environmental contamination.

### SUMMARY

Embodiments of this disclosure relate generally to fuel filter systems that do not require periodic water draining. More specifically, the embodiments relate to a fuel filter system that includes an emulsifier that produces water-fuel emulsions that may then be burned in an engine such that water does not accumulate in the fuel filter system.

In one embodiment, a fuel filter system includes a fuel pump, a fuel filter fluidly coupled to a high pressure side of the fuel pump, and an orifice fluidly coupled to the fuel filter. The orifice is configured to produce a fuel-water emulsion from a water and fuel mixture received from the fuel filter, and the fuel-water emulsion is supplied to a portion of the fuel filter system on a suction side of the fuel pump. The fuel filter system may include an additional filter fluidly coupled to the suction side of the fuel pump, and a fuel tank fluidly coupled to the suction side of the fuel pump. An engine may be fluidly coupled to the fuel filter.

In another embodiment, a method for eliminating water from a fuel filter system includes emulsifying a mixture of water and fuel received from a fuel filter at an orifice to form a water-fuel emulsion, providing the water-fuel emulsion to a portion of the fuel filter system on a suction side of a fuel pump, passing the water-fuel emulsion through the fuel filter, and providing the water-fuel emulsion to an engine. The orifice may be located at a high pressure side of the fuel pump.

### BRIEF DESCRIPTION OF THE DRAWINGS

References are made to the accompanying drawings that form a part of this disclosure, and which illustrate the embodiments in which the systems and methods described in this specification can be practiced.

FIG. 1 is a schematic view of a conventional fuel filter system.

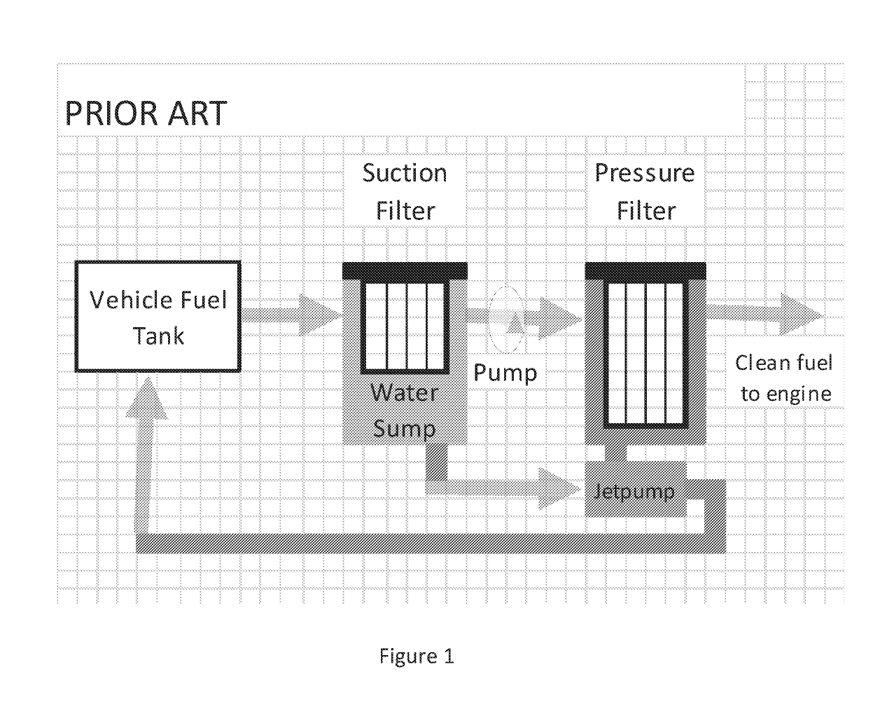

FIG. 2 is a schematic view of a fuel filter system with a water emulsifier and a number of alternative water-fuel emulsion return paths, according to a first embodiment.

FIG. 3 is a schematic view of a fuel filter system with a water emulsifier according to a second embodiment.

FIG. 4 is a schematic view of a fuel filter system with a water emulsifier according to a third embodiment.

FIG. 5 is a schematic view of a fuel filter system with a water emulsifier according to a fourth embodiment.

FIG. 6 is a schematic view of a fuel filter system with a water emulsifier according to a fifth embodiment.

FIG. 7 is a flow diagram of an example method of eliminating water from a fuel filter system.

### DETAILED DESCRIPTION

Embodiments described and depicted herein relate generally to a fuel filter system. More specifically, the embodiments relate to a fuel filter system including a water emulsifier.

The fuel filter systems described herein include a water emulsifier that produces a water-fuel emulsion from a mixture of water and fuel received from the fuel filter. The water-fuel emulsion is returned to the fuel system in small enough droplets that it passes through the fuel filter and then passes to an engine. The water-fuel emulsion is then combusted in the engine, removing the water from the fuel system. Thus, the fuel filter system does not require the periodic draining of water accumulated in a water sump in the system. This allows the fuel filter system to avoid the risks of environmental contamination associated with draining a fuel filter system water sump and eliminates the risk that a user will neglect to drain the water sump and cause damage to the fuel system and engine. For example, a prolonged presence of water in a water sump may result in microbial growth that increases the acidity of the fuel, thereby increasing corrosion potential to the fuel system.

The fuel filter system includes a fuel pump, a fuel filter and a water emulsifier. The water emulsifier emulsifies a mixture of water and fuel received from the fuel filter. The water emulsifier may comprise an orifice through which the water and fuel mixture passes. The water emulsifier may have a high pressure side that is in fluid communication with the fuel filter and a low pressure side that is fluidly coupled to a portion of the fuel filter system located on a suction side of the fuel pump. As utilized herein, a “high pressure side” refers to the side of the fuel pump from which fuel flows, while a “suction side” refers to the side of the fuel pump to which fuel is supplied. The pressure differential between the sides of the water emulsifier provides the motive force that drives the water and fuel mixture through the water emulsifier, and thereby produces the water-fuel emulsion. The fuel filter system may include a plurality of water emulsifiers, and each water emulsifier may include a plurality of orifices, such that the throughput of the water emulsifiers is incrementally increased with the addition of each water emulsifier and/or orifice. The water emulsifier orifice may comprise a portion of a structure, with the portion having a cross-section that is smaller than the cross-section of the fuel passage immediately downstream of the water emulsifier orifice. For example, the water emulsifier orifice may be an outlet of the fuel filter through which the water and fuel mixture exits the fuel filter, with a fuel conduit that receives the output of the orifice having a larger cross-section than the orifice. Alternatively, the water emulsifier orifice may be a restriction in a fuel conduit, such that the cross-section of the orifice is smaller than the cross-section of the fuel conduit in which it is located. Other constructions for the water emulsifier orifice may also be used.

The fuel pump may be any pump capable of pumping fuel at an appropriate pressure. The fuel pump may produce high pressure fuel on a high pressure side of the fuel pump, such as fuel with a pressure of about 1,000 kPa or more. The fuel pump may be selected to have sufficient throughput to support the uninterrupted operation of an engine supplied by the fuel filter system, and may be mechanically driven by an engine, electronically controlled, and/or computer controlled. The fuel pump may be resistant to degradation due to the presence of water in the fuel.

The fuel filter may be any fuel filter suitable for fluid coupling with the high pressure side of the fuel pump, which may be referred to as a pressure side filter. The fuel filter may include a replaceable fuel filter element, such as a filter cartridge. The filter element may additionally include a particulate filter and/or a water separator element that enhances the ability of the filter to remove large water droplets from the fuel. Alternatively, the fuel filter may be free of a filter element, such as a fuel filter that includes pressure housing that forms a settling chamber that allows water droplets to separate from the fuel. A first outlet is provided in the fuel water filter separator through which fuel filtered by the fuel water filter separator may pass to a fuel conduit fluidly connected to the engine. A second outlet is fluidly coupled to the water emulsifier. The second outlet is provided in the fuel filter such that water that is separated from the fuel by the fuel filter is removed from the fuel filter through the second outlet. The second outlet may be positioned such that water removed from the fuel by the fuel filter is motivated towards the second outlet, such as by gravity or the flow pattern of the fuel filter. In addition to the water, some fuel passes through the second outlet and to the water emulsifier. The fuel filter may be free of a water sump or a water drain that drains the water directly to the environment.

The fuel filter system may include an additional filter located on the suction side of the fuel pump, which may be referred to as a suction side filter. The additional filter may be a particulate filter, and the additional filter may be selected to remove particulates that are larger than the particulates removed from the fuel by the fuel filter. The additional filter may also include a water separator element. The additional filter may be any appropriate filter, and the additional filter may include a replaceable filter element, such as a filter cartridge. The additional filter includes an outlet fluidly coupled to the suction side of the fuel pump, and an inlet that receives unfiltered fuel. The additional filter may be free of a water sump or a water drain that drains the water directly to the environment.

The fuel filter system may include a fuel tank. The fuel tank may be any appropriate fuel tank that can accommodate fuel, such as fuel that contains some amount of water. The fuel tank may be in fluid communication with the suction side of the fuel pump or the inlet of the additional filter. The fuel tank may be free of a water sump or a water drain that drains the water directly to the environment.

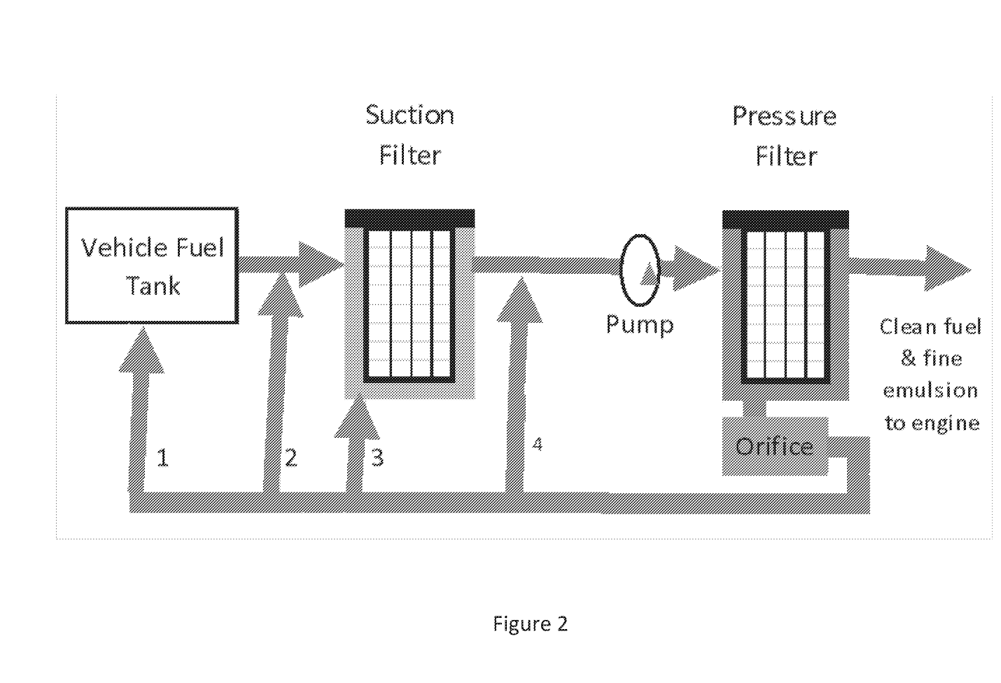

The water-fuel emulsion produced by the water emulsifier may be returned to the fuel system at any point on the suction side of the fuel pump. As shown in FIG. 2, possible return points for the water-fuel emulsion include the fuel tank, suction side filter, the conduit between the suction side filter and the fuel pump, and the conduit between the fuel tank and the suction side filter. These return points allow the water-fuel emulsion to pass through the fuel pump and the fuel filter. In the fuel filter, the water droplets in the water-fuel emulsion that are too large to pass through the fuel filter element are separated from the fuel and pass through the water emulsifier again. The water droplets in the water-fuel emulsion that are small enough to pass through the fuel filter element pass out of the fuel filter and to the engine to be combusted along with the clean fuel. Recirculation of water through the emulsifier reduces the size of the water droplets, forming a more stable emulsion because smaller water droplets take a longer time to separate from the fuel. The water droplets of the more stable emulsion remain entrained in the fuel flow and do not separate as the fuel travels through the fuel system and is combusted.

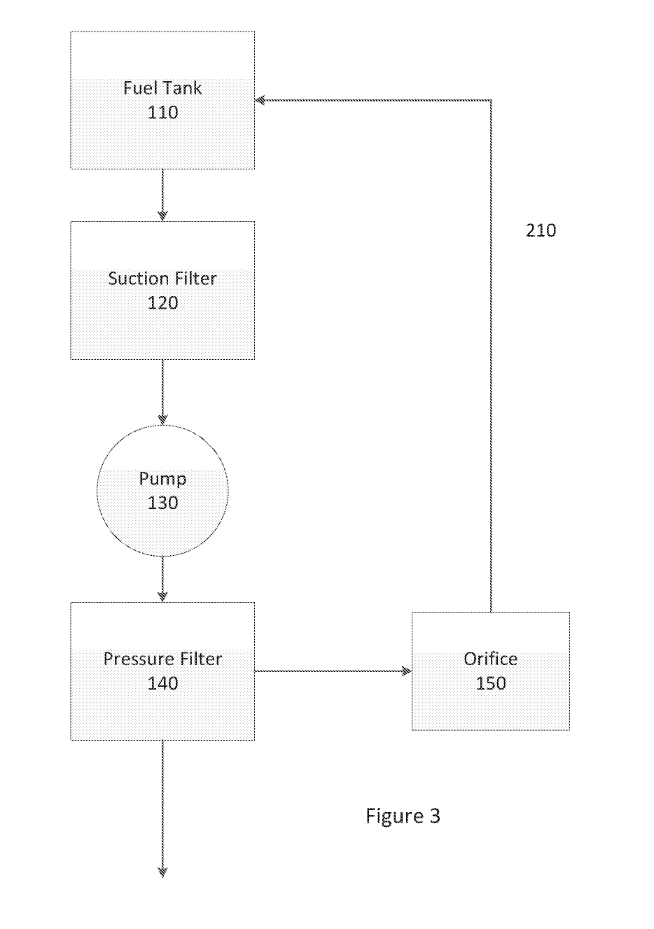

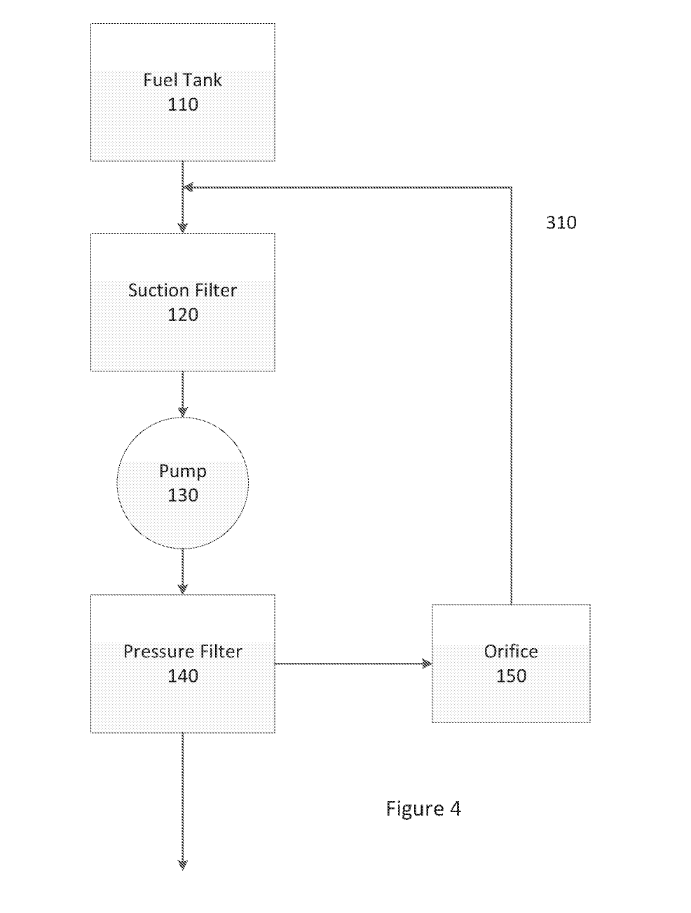

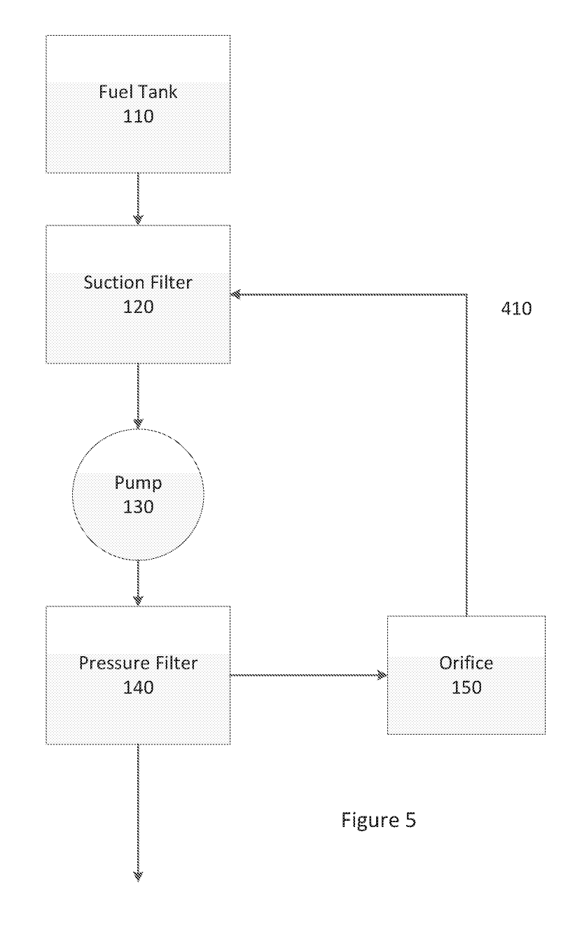

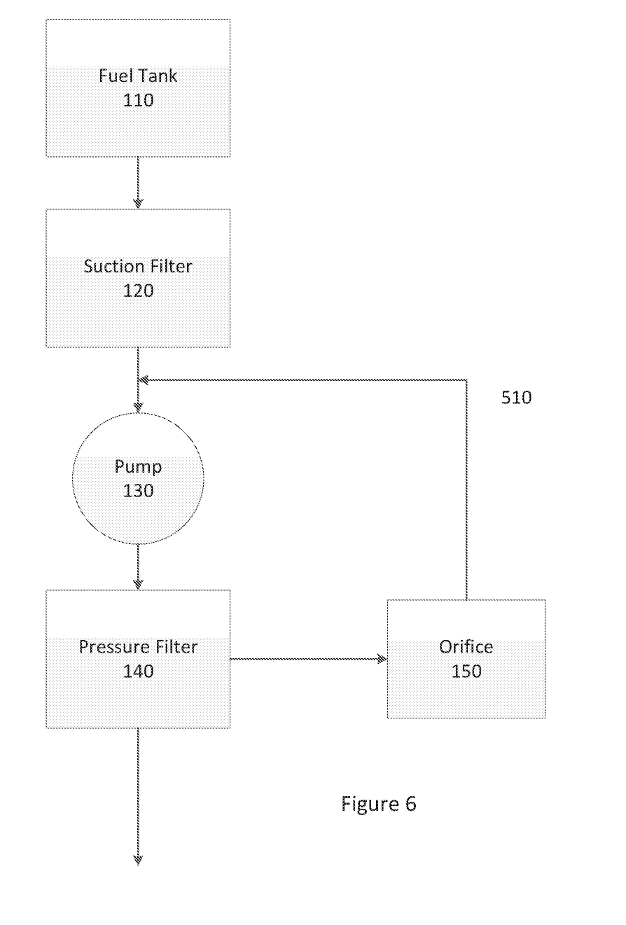

FIG. 3 illustrates a fuel filter system in which the water-fuel emulsion is returned to the fuel tank 110. The fuel filter system includes the fuel tank 110, a suction side filter 120, a fuel pump 130 and a pressure side filter 140 which are fluidly connected in that sequence. The pressure side filter 140 includes a first outlet that supplies clean fuel to an engine, and a second outlet that supplies a water and fuel mixture to a water emulsifying orifice 150. The water emulsifying orifice 150 produces a water-fuel emulsion and that is supplied to the fuel tank by a fuel conduit 210. Similarly, FIG. 4 illustrates a fuel filter system in which the water-fuel emulsion is returned to a fuel conduit between the fuel tank 110 and the suction side filter 120. The water-fuel emulsion is carried from the water emulsifying orifice 150 to the return point by fuel conduit 310. FIG. 5 illustrates a fuel filter system in which the water-fuel emulsion is returned to the suction side filter 120. The water-fuel emulsion is carried from the water emulsifying orifice 150 to the return point at the suction side filter by fuel conduit 410. FIG. 6 illustrates a fuel filter system in which the water-fuel emulsion is returned to a fuel conduit between the suction side filter 120 and the fuel pump 130. The water-fuel emulsion is carried from the water emulsifying orifice 150 to the return point by fuel conduit 510.

The fuel filter system may manage water contained in the fuel without any active control by an operator or controller. The design of the water emulsifier that utilizes the pressure differential between the high pressure side of the fuel system and the suction side of the fuel system allows the filter system to actively manage water present in the fuel any time the fuel pump and engine are in operation. The water emulsifier may be considered a passive system, in that no activation of the system is required beyond operation of the fuel pump and engine. The fuel filter system may operate without the aid of water-in-fuel sensors.

Alternatively, the fuel filter system may additionally include an electronic controller. The electronic controller may be coupled to a water-in-fuel sensors, an electronically controlled valve and/or the fuel pump. The electronically controlled valve may be positioned such that the valve controls flow from the fuel filter element to the water emulsifier. The controller may be programmed to open and close the electronically controlled valve based on input from the water-in-fuel sensor or the state of the engine and/or fuel pump. For example, the controller may close the electronic valve to prevent flow to the water emulsifier when the engine is in a high load condition or at startup and a maximum fuel flow to the engine is required. The controller may also open the electronic valve when the water-in-fuel sensor detects the presence of water in the fuel filter system. The controller may also be coupled to a warning indicator configured to alert a user when the water-in-fuel sensor indicates that the water level in the fuel filter system exceeds the capacity of the water emulsifier. For example, if fuel that is highly contaminated with water is supplied to the fuel tank, the water-in-fuel sensor may detect the excess water level and alert an operator that there is a problem with the fuel system, allowing the operator to prevent damage to the engine when the water emulsification capacity of the fuel filter system is exceeded.

The fuel filter system does not require the periodic draining of water, and the system may be completely free of water sumps and drains. Thus, the risk of improper operator drain maintenance resulting in damage to the fuel system and engine is avoided. Additionally, the risk of environmental contamination associated with draining water from the fuel system is avoided. Tests have indicated that supplying the water-fuel emulsion with sufficiently small water droplets to pass through the fuel filter to the engine does not result in damage to the engine or fuel injection system. Thus, the fuel filter system described herein avoids the drawbacks of pre-existing fuel filter systems without decreasing the protection of the engine and fuel injection system. The inclusion of the water emulsifier orifice in a separate flow path from the main fuel flow path avoids a restriction on the main fuel flow path, which prevents the degradation of the fuel flow in the system as a result of the water emulsifying orifice.

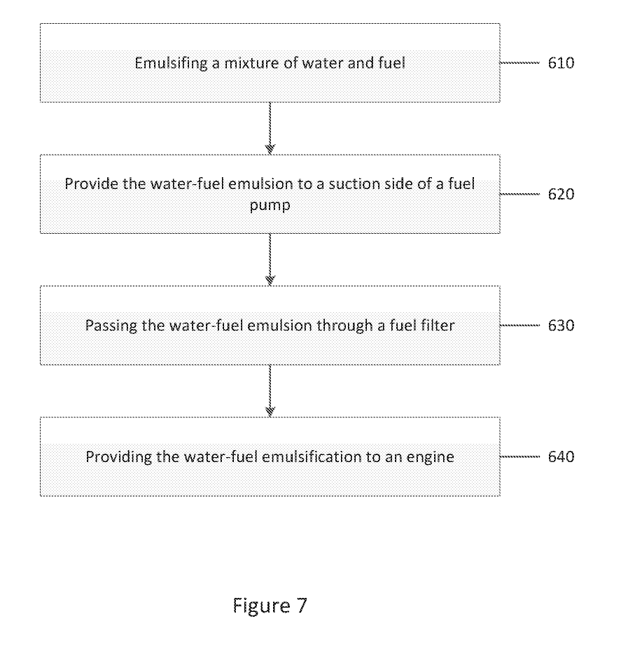

A method of eliminating water from a fuel filter system is also provided. A flow chart providing a general overview of an example method of eliminating water is illustrated in FIG. 7. The method includes the emulsification of a water and fuel mixture at 610. The water and fuel mixture may be received from a fuel filter located at a high-pressure side of a fuel pump, and the emulsion may be achieved by passing the high-pressure water and fuel mixture through an orifice. The resulting water-fuel emulsion is then provided to the fuel filter system on the suction side of the fuel pump at 620. For example, the water-fuel emulsion may be returned to the fuel tank, to a suction side filter, to a conduit between the suction side filter and a fuel pump, or to a conduit between the fuel tank and the suction side filter. The water-fuel emulsion may then optionally be passed through a suction side filter, before being passed through the fuel pump. The water-fuel emulsion is then passed through the fuel filter at 630 and is provided to an engine at 640. The water-fuel emulsion is combusted in the engine, removing the water from the fuel filter system. The fuel filter systems described herein may be utilized to carry out the method of eliminating water from a fuel filter system.

Implementations described in this specification can be implemented in digital electronic circuitry, or in computer software, firmware, or hardware, including the structures disclosed in this specification and their structural equivalents, or in combinations of one or more of them. The implementations described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a controller or a data processing apparatus on data stored on one or more computer-readable storage devices or received from other sources. The term “data processing apparatus” or “controller” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for a computer program, e.g., code that constitutes processor firmware, a protocol stack, a database management system, an operating system, a cross-platform runtime environment, a virtual machine, or a combination of one or more of them.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed:

1. A fuel filter system, comprising:
a fuel pump;
a fuel filter fluidly coupled to a high pressure side of the fuel pump; and
an orifice fluidly coupled to the fuel filter, the orifice configured to produce a fuel-water emulsion from a water and fuel mixture received from the fuel filter,
wherein the fuel-water emulsion is supplied to a portion of the fuel filter system on a suction side of the fuel pump.

2. The fuel filter system of claim 1, further comprising an additional filter fluidly coupled to the suction side of the fuel pump.

3. The fuel filter system of claim 2, wherein the portion is the additional filter.

4. The fuel filter system of claim 1, further comprising a fuel tank fluidly coupled to the suction side of the fuel pump.

5. The fuel filter system of claim 4, wherein the portion is the fuel tank.

6. The fuel filter system of claim 1, further comprising an engine fluidly coupled to the fuel filter.

7. The fuel filter system of claim 6, further comprising a fuel outlet that supplies clean fuel to the engine from the fuel filter.

8. The fuel filter system of claim 7, wherein the clean fuel includes emulsified water droplets that are small enough to pass through the fuel filter.

9. The fuel filter system of claim 1, wherein the fuel filter does not include a water sump or a water drain that drains the water directly to the environment.

10. The fuel filter system of claim 1, further comprising a fuel conduit configured to transport the fuel-water emulsion to the portion.

11. The fuel filter system of claim 10, wherein the orifice has an orifice cross-section that is smaller than a cross-section of the fuel conduit immediate downstream of the orifice.

12. The fuel filter system of claim 1, further comprising a plurality of orifices coupled to the fuel filter, the plurality of orifices comprising the orifice, each of the plurality of orifices configured to produce the fuel-water emulsion from the water and fuel mixture received from the fuel filter.

13. A method for eliminating water from a fuel filter system, comprising:
emulsifying a mixture of water and fuel received from a fuel filter at an orifice to form a water-fuel emulsion;
providing the water-fuel emulsion to a portion of the fuel filter system on a suction side of a fuel pump;
passing the water-fuel emulsion through the fuel filter; and
providing the water-fuel emulsion to an engine.

14. The method of claim 13, wherein the orifice is located at a high pressure side of the fuel pump.

15. The method of claim 13, further comprising passing a mixture of water and fuel through a suction-side filter before providing the mixture through the fuel filter.

16. The method of claim 15, wherein the suction-side filter is the portion of the fuel filter system.

17. The method of claim 13, wherein the portion is the fuel tank.

18. The method of claim 13, wherein the fuel filter does not include a water sump or a water drain that drains the water directly to the environment.

19. The method of claim 13, wherein providing the water-fuel emulsion to the portion comprises passing the water-fuel emulsion through a fuel conduit configured to transport the water-fuel water emulsion to the portion.

20. The method of claim 19, wherein the orifice has an orifice cross-section that is smaller than a cross-section of the fuel conduit immediate downstream of the orifice.
